(19) United States
(12) Patent Application Publication
(10) Pub. No.: US 2008/0059258 A1
(43) Pub. Date: Mar. 6, 2008

(54) Method and System for Selecting Search List Table in Internet Search Engine in Response to Search Request

(75) Inventor: Woo Sung Lee, Seoul (KR)

Correspondence Address: BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 11/571,155

(22) PCT Filed: Jun. 23, 2005
(86) PCT No.: PCT/KR05/01952

§ 371 Date: Dec. 21, 2006

(30) Foreign Application Priority Data
Jun. 24, 2004 (KR) 10-2004-0047668

(51) Int. Cl. G06F 17/30; G06Q 30/00

(52) U.S. Cl. 705/7; 705/14; 705/400

(57) ABSTRACT

There are provided a keyword advertisement service method and a system including: a step of maintaining a search information database for storing at least one search listing in correspondence to a predetermined keyword; a step of receiving 5 information on predetermined bid participation cost in association with extracting the search listing from the advertiser; a step of extracting at least a part of the search listings corresponding to the keyword inputted for the search request; and a step of arranging the extracted search listings into a search result list by rolling the same and providing the search result list as a search result of the search request, wherein Step of extracting 0 at least the part of the search listings corresponding to the keyword inputted for the search request includes: a step of giving an extraction ranking to each of the search listings corresponding to the keyword based on the bid participation cost and a predetermined additional factor and a step of extracting search listings within a set-up ranking.

### TECHNICAL FIELD

The present invention relates to a keyword advertisement service system and a keyword advertisement system extracting a search listing in response to a search request, and more particularly, to a keyword advertisement service method and a keyword advertisement service system which select a search listing to be extracted by considering additional factors in addition to a bid participation cost and arrange the selected search listing at random by rolling in a keyword advertisement extracting a search listing of an advertiser in response to a predetermined search request.

### BACKGROUND ART

Nowadays, information search via a communication network is generalized according to rapid improvement of a communication network such as Internet. An Internet user (a searcher) easily obtains needed information, and the information search changes various parts of the entire life of us.

The information search may be performed by providing a search result screen according to a search request of a searcher, in which a search listing of an advertiser in a predetermined contract is provided to the searcher generating the search request. The providing the search listing by the advertiser may generate an effect to perform public relations on the advertiser to the searcher. ‘A keyword advertisement’ that provides systemic advertisement services is generalized and actively managed in the search site industry.

An advertiser in the keyword advertisement tries to locate a search listing of the advertiser at an exposure position whose exposure frequency to searchers and the number of clicks is high, and the advertiser presents a higher cost as a bidding cost in order to obtain a right to display in the rare exposure position. Also, a large amount of an advertisement cost corresponding to the bidding cost has to be paid, and there may be generated an evil to adding a considerable cost load on the advertiser. In addition, there is generated an adverse effect that a bid participation cost is continuously raised due to an excessive competition among advertisers to obtain an exposure position whose ranking is high.

Also, in a method of determining an exposure position of a search listing by the order of the size of a bid participation cost, it may be not guaranteed that an advertisement effect expected by an advertiser increases in proportion to the arrangement order of the exposure position. Namely, it is true that an expected advertisement effect of an exposure position whose bidding cost may be not asserted to be more profitable than an exposure position whose bidding cost is relatively low. Only, in case that a search listing of an advertiser is located within a predetermined higher rank, though a difference in the frequency of exposure or the number of click may exist more or less, an actual advertisement effect may not be much different. Accordingly, it may be preferable that proper exposure frequency or click number is provided to advertisers and relatively low advertisement cost is charged on advertisers in order to provide a reasonable keyword advertisement service.

To solve the problem, Korean Patent Application No. 2004-0007758 discloses a method of exposing a search listing, in which a predetermined number of search listings are selected based on a bid participation cost and at least one selected search listing is arranged at random according to a random arrangement order. However, in the method of selecting a search listing, a search listing is still selected based on the bid participation cost inputted by an advertiser, thereby inducing a continuous increment of an advertisement cost due to competition among advertisers. Namely, while a search listing of an advertiser paying a high advertisement cost is continuously selected at a high rate, on the other hand a search listing of an advertiser who can not present a high bidding cost has little opportunity of being selected and is always disadvantaged in advertisement competition.

Accordingly, a more reasonable keyword advertisement model is desperately needed, in which an impartial advertisement opportunity that is not largely changed due to an arrangement order in which a search listing of an advertiser is located is provided, a proper advertisement cost is charged, and a profit of an advertiser is maintained together. In addition, a keyword advertisement model that can select a search listing based on more various data, getting out of the method of selecting a search listing based on only bidding cost.

### DISCLOSURE OF INVENTION

Technical Goals

The present invention is provided to solve the problems as described above, there are provided a keyword advertisement service method and a keyword advertisement service system extracting a search listing in response to a search request, which determine an extraction ranking by reflecting an advertisement effect according to an advertisement period of the search listing and the popularity among searchers in addition to a bid participation cost, thereby giving an impartial advertisement opportunity with respect to the search listing and extracting a search listing optimized to the searcher.

According to the present invention, there are also provided a keyword advertisement service method and a keyword advertisement service system extracting a search listing in response to a search request, which arrange the extracted search listing at random by rolling, thereby excluding excessive competition for occupying an exposure position, and charging an identical advertisement cost on the search listing regardless of the exposure position, thereby computing a reasonable advertisement cost.

According to the present invention, there are also provided a keyword advertisement service method and a keyword advertisement service system extracting a search listing in response to a search request, in which it is restricted that an extraction ranking to the same exposure position is continuously determined such that the exposure position where the extracted search listing is displayed is not monopolized by a certain search listing, thereby flexibly controlling the determination on the extraction ranking of the search listing.

Technical Solutions

According to an aspect of the present invention, there is provided a keyword advertisement service method extracting a search listing of an advertiser in response to a search request, including: a step of maintaining a search information database for storing at least one search listing in correspondence to a predetermined keyword; a step of receiving information on predetermined bid participation cost in association with extracting the search listing from the advertiser; a step of extracting at least a part of the search listings corresponding to the keyword inputted for the search request; and a step of arranging the extracted search listings into a search result list by rolling the same and providing the search result list as a search result of the search request, wherein Step of extracting at least the part of the search listings corresponding to the keyword inputted for the search request includes: a step of giving an extraction ranking to each of the search listings corresponding to the keyword based on the bid participation cost and a predetermined additional factor and a step of extracting search listings within a set-up ranking.

According to another aspect of the present invention, there is provided a keyword advertisement service system extracting a search listing of an advertiser in response to a search request, including: a search information database for storing at least one search listing corresponding to a predetermined keyword; an interface means receiving information on a predetermined bid participation cost in association with the extraction of the search listing from the advertiser; a search result extraction means extracting at least a part of the search listing corresponding to the keyword inputted for the search request; and a search result list generation means arranging the extracted search listing to arrange in a predetermined search result list and providing the search result list as a search result of the search request, wherein the search result extraction means performs the operations of: measuring click through rate (CTR) for exposure, with respect to the search listing for a predetermined advertising period, received from the advertiser; determining an extraction ranking with respect to each of the search listing by using at least one of the advertising period, the click through rate (CTR) for exposure, and the bid participation cost; and extracting a search listing not more than a predetermined order based on the determined extraction ranking.

### BRIEF DESCRIPTION OF DRAWINGS

FIG. 1 is a diagram schematically illustrating the configuration of a keyword advertisement service system of the present invention;

FIG. 2 is a configuration diagram illustrating a keyword advertisement service system 200 according to a preferable embodiment of the present invention;

FIG. 3 is a diagram illustrating an example of the configuration of a search information database according to the present invention;

FIGS. 4 through 7 are diagrams illustrating determining an extraction ranking of a search listing;

FIGS. 8 and 9 are diagrams illustrating an example of determining an advertisement cost different for each search listing by using a grade index according to the present invention;

FIG. 10 is a flow chart concretely illustrating a keyword advertisement service method according to a preferable embodiment of the present invention;

FIG. 11 is a flow chart illustrating an example of a method of determining an extraction ranking of a search listing;

FIG. 12 is flow chart illustrating an example of a method of giving an extraction ranking of a search listing by using an advertisement period as an additional factor according to the present invention;

FIG. 13 is flow chart illustrating an example of a method of giving an extraction ranking of a search listing by using a click through rate (CTR) as an additional factor;

FIG. 14 is flow chart illustrating an example of a method of giving an extraction ranking of a search listing by using an advertisement period and a click through rate (CTR) as additional factors;

FIG. 15 is a flow chart illustrating an example of a method of excluding an operation of sequentially giving the same extraction ranking to a certain search listing by recording random rankings, which is according to the present invention;

FIG. 16 is a block diagram of the inside of a general use computer apparatus that may be employed in performing the keyword advertisement service method according to the present invention.

### BEST MODE FOR CARRYING OUT THE INVENTION

Hereinafter, A keyword advertisement service method and a system of the same will be described with reference to the attached drawings.

A rolling used in the present specification means a process in which the arrangement order of search listings arranged on a search result list is determined at random such that an exposure position of a certain search listing extracted as a search result is changed every time when a new search request is generated. Namely, the rolling may allow the arrangement order of the search listing to be continuously changed such that an exposure position for independently showing one search listing to a searcher performing a search request is not monopolized by a certain search listing.

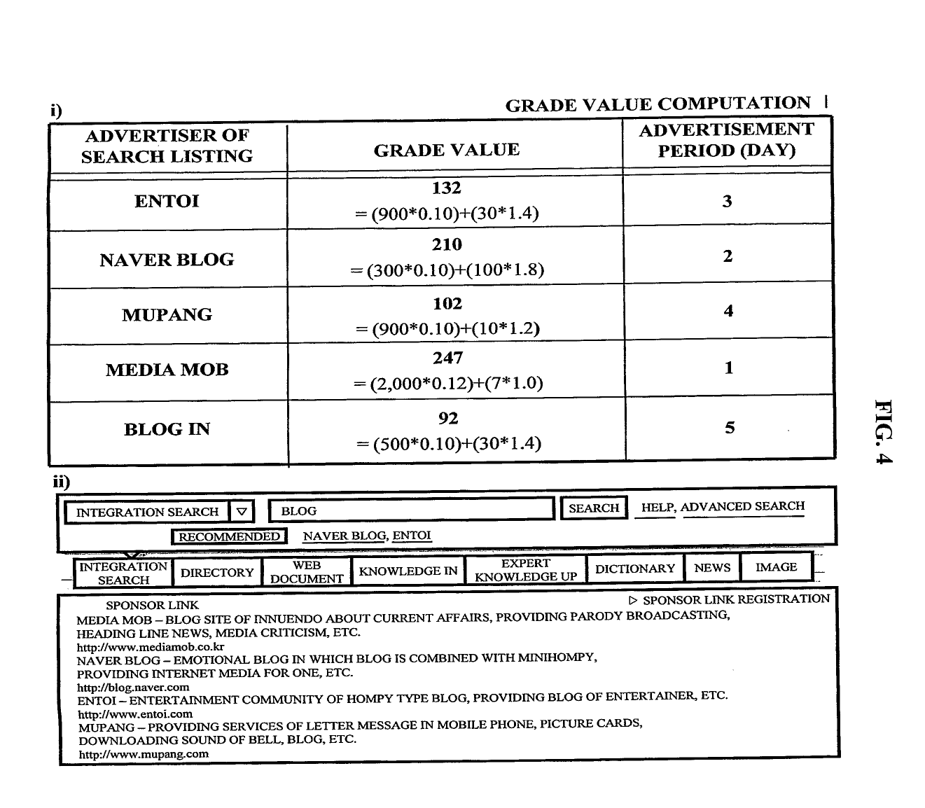

Also, a search listing is extracted corresponding to a certain keyword inputted to a search engine and may indicate one search result item provided to a searcher requesting a search. A search listing may include brief information on an information site run by an advertiser, such as contents title, contents summary, and a network address. For example, a search listing of FIG. 3, which is extracted by a keyword ‘blog’, includes “naver blog “as contents title, http://blog.naver.com” as a network address, and other contents summary. Also, a search result list may designate an arrangement list of search listings, in which at least one search listing as a search result corresponding to a search request of a searcher is shown in a certain exposure position according to an arrangement order determined by the rolling.

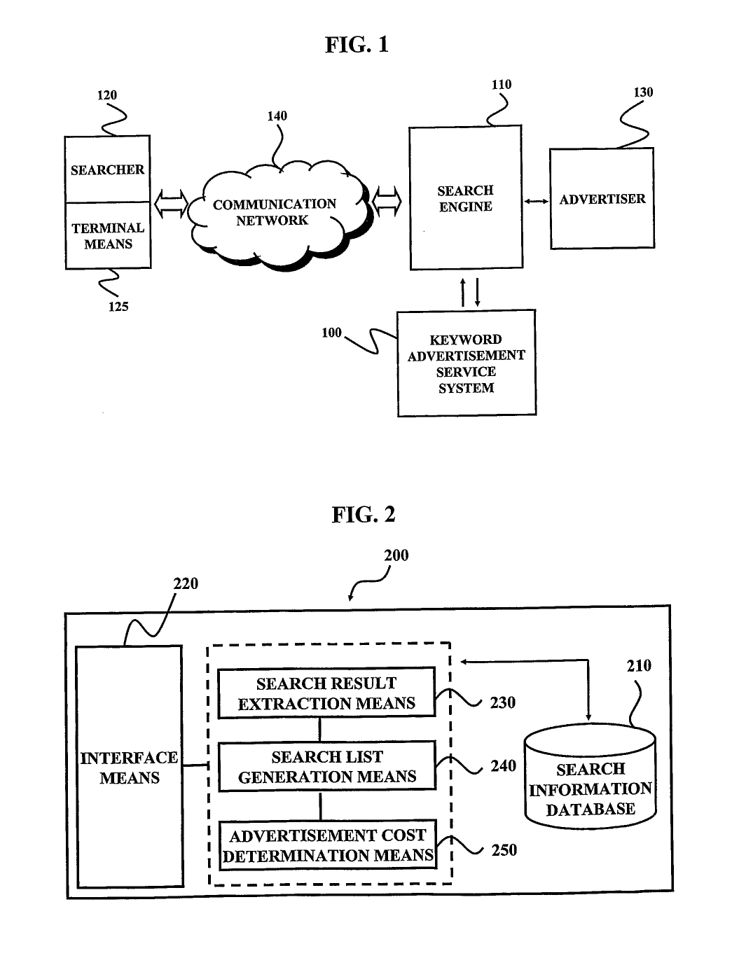

FIG. 1 is a diagram schematically illustrating the configuration of a keyword advertisement service system of the present invention.

A keyword advertisement service system 100 extracts a predetermined number of search listings corresponding to a keyword inputted for requesting a search in a search engine 110, and the predetermined number of search listings selected according to an extraction ranking of each search listing are extracted. For this, in case that a predetermined keyword is inputted for requesting a request, the keyword advertisement service system 100 receives information on a bid participation cost from an advertiser 130 making a request for extracting an associated search listing and defines a predetermined additional factor associated with computing a grade value of the search listing. The bid participation cost and the additional factor may be used as standard data for selecting/extracting a certain search listing corresponding to the search request.

The search engine 110 may designate a search program or a search web server supporting a search operation in order to easily access a web site having contents data that a searcher 120 wants to find. Namely, the search engine 110 provides brief information (preferably, a search listing of the present invention) on the advertiser 130 who can provide information that the searcher 120 want, in response to a search request of the searcher 120, thereby saving a time used in searching the contents data and improving the precision of search data. Particularly, since each of the brief information (a search listing) includes predetermined link information, in case that a click selection (for example, click a mouse) of the searcher 120 is generated with respect to brief information (search listing) shown in a terminal means 125, the search engine 110 allows the searcher 120 to access the advertiser 130. The search engine 110 may be divided into word-oriented searching and subjected-oriented searching according to an access type of the search operation. In order to achieve the goal of the present invention, in which a certain search listing extracted corresponding to an inputted keyword is displayed on a search screen in an arrangement order determined at random by rolling, the search type of the search engine 110 is described being limited to the word-oriented searching. It is an example only for convenience of description that the search of the search engine 110 is limited to the word-oriented searching, it stands to reason to those skilled in the art that the described above is not the limitation of the technical scope of the present invention.

The searcher 120 may designate an Internet user who has the terminal means 125 for accessing the keyword advertisement service system 100 of the present invention and generates a search request with respect to a web site of the advertiser 130 having contents data to obtain by inputting a predetermined keyword in the search engine 110.

The advertiser 130 may designate a contents provider (CP) running a web site whose location on network is designated by a network address (for example, IP address, URL, and domain). The advertiser 130 requests registering a keyword advertisement with respect to a certain keyword, thereby providing a search listing associated with the company of the advertiser 130 to the searcher 120 in case that a search request is generated by inputting a keyword. Also, the advertiser 130 may pay a predetermined advertisement cost generated according to click selection of the searcher 120, with respect to a search listing, to a system manager according to the present invention.

The terminal means 125 maintains a state of accessing the keyword advertisement service system 100 via a communication network 140 such as Internet and displays at least one search listing (or a search result list in which search listings are arranged) extracted by the search operation of the search engine 110 on the search screen. The terminal means 125 may designate a terminal having predetermined computation ability by including a predetermined memory and equipped with a predetermined microprocessor, such as a personal computer, a handheld computer, a Personal Digital Assistant (PDA), an MP3 player, an electronic dictionary, a mobile phone, and a smart phone.

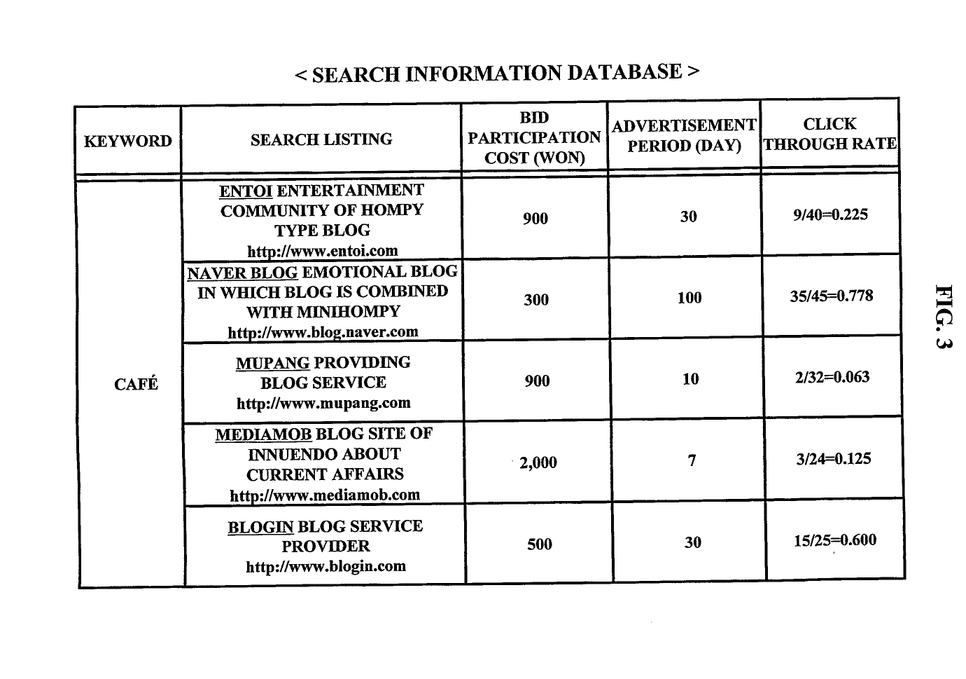

In association with displaying a search listing as a search result, the keyword advertisement service system 100 arranges at least one search listing into a search result list by rolling the same in a random order and provides the search result list to the searcher 120. Particularly, the keyword advertisement service system 100 allows an advertisement cost with respect to a search listing shown to the searcher 120 to be added according to click selection of the searcher 120, thereby charging a reasonable advertisement cost on the advertiser 130. Hereinafter, a concrete configuration of a keyword advertisement service system 200 of the present invention will be described with reference to FIG. 2.

FIG. 2 is a configuration diagram illustrating the keyword advertisement service system 200 according to a preferable embodiment of the present invention.

The keyword advertisement service system 200 includes a search information database 210, an interface means 220, a search result extraction means 230, a search result list generation means 240, and an advertisement cost determination means 250.

The search information database 210 is a unit for storing at least one search listing corresponding to a predetermined keyword. Namely, the search information database 210 records and maintains a keyword inputted by the advertiser 130 for registering a keyword advertisement to be associated with a search listing of the advertiser 130. In this case, a keyword is a cause to extract a search listing corresponding to a search request of the searcher 120 and may be a substantive that is possible to be independently identified but not particularly limited in the present invention. A keyword received for registering a keyword advertisement may be selected by random selection of each of the advertiser 130. For example, the search information database 210 may classify and store a search listing of the advertiser 130 inputting the same keyword and allows identifying all search listings corresponding to a keyword inputted for requesting a search (refer to FIG. 3).

The interface means 220 is a unit receiving information on a predetermined bid participation cost from the advertiser 130 in association with extracting a search listing. The interface unit 220 receives a bid participation cost as betting participating in selecting a search listing extracted in response to a search request of the searcher 120. In this case, the bid participation cost may be a comparison standard for preferentially extracting a search listing stored in association with the keyword advertisement and may be an advertisement cost that is allowed as a maximum charge on the advertiser 130 in case that a search listing provided (shown) to the searcher 120 in response to the search request is click selected by a command input device of the searcher 120.

A unit click cost according to one click with respect to a search listing of the searcher, a unit exposure cost according to provide a search result list in which rolled search listings are arranged to the searcher 120, a unit purchase cost according to accomplishing a predetermined deal between the advertiser 130 and the searcher 120 may be the bid participation cost illustrated in the present embodiment. Hereinafter, for convenience of description, the unit click cost is set-up and described as the bid participation cost. For example, at a time point that a click selection of the searcher 120 is generated with respect to a search listing arranged into a search result list by rolling, a unit click cost satisfying a predetermined condition as a bid participation cost may be charged on the advertiser 130 for an advertisement cost. The predetermined condition may be flexibly and variously set-up by the manager of the present system. In the present embodiment, it is illustrated that the predetermined condition is set-up in order to determine a minimum bid participation cost from bid participation costs associated with a search listing arranged in the search result list to be the advertisement cost. Hereinafter, it will be described that a bid participation cost is associated with each search listing corresponding to a predetermined keyword, with reference to FIG. 3.

FIG. 3 is a diagram illustrating an example of the configuration of the search information database according to the present invention.

As described above, the search information database 210 stores at least one search listing corresponding to a certain keyword and information on a bid participation cost associated with each of search listings. Accordingly, in case that a certain keyword is inputted by the searcher 120, a search listing including the keyword as a factor of extraction can be easily identified and determining an extraction ranking of a search listing can be precisely performed by using a bid participation cost stored in association with the identified search listing. The extraction ranking is a standard data to recognize a search listing to be preferentially extracted in response to a search request.

For example, it is illustrated in FIG. 3 that the search 210 stores a search listing of the advertisers 130 commonly registering a keyword ‘blog’ as a keyword advertisement by grouping. Namely, in case that the keyword ‘blog’ is inputted by the searcher 120, the search information database 210 maintains a search listing associated with an advertiser such as ‘naver blog’, which may be extracted as a search result. Also, information on a bid participation cost inputted from the advertiser 130 of the search listing is associated with each of search listings stored in the search information database 210, and the information may be used as data to determine an extraction ranking of each search listing. As described above, the bid participation cost may be differently inputted into each search listing according to random determination of the advertiser 130, as the maximum advertisement cost charged on the advertiser 130, which is generated according to click selection with respect to a search listing. Also, additional factors may participate in determining an extraction ranking of a search listing in addition to the bid participation cost in the present embodiment, and a grade value for determining an extraction ranking can be computed by applying a predetermined weight to each of the additional factors. Detailed description associated with the computation of the grade value using the additional factors will be described later.

The search result extraction means 230 is a unit extracting at least some of search listings corresponding to a keyword inputted for a search request. The search result extraction means 230 extracts a predetermined number of search listings optimized as a search result, in response to a search request of the searcher 120 by using the search engine 110. Namely, the search result extraction means 230 designates a predetermined number of search listings arranged in a search result list from at least one search listing stored in the search information database 210, in response to a keyword. In the present embodiment, an extraction ranking with respect to a search listing is determined by comparing a grade vale computed by using the described bid participation cost and the additional factor. The additional factor is for getting out of intolerance of an extraction standard due to a method of extracting a search listing base on a bid participation cost, namely, a limitation that a search listing of the advertiser 130 who inputs a high bid participation cost is always preferentially extracted. In the present embodiment, an advertisement period with respect a search listing or click through rate (CTR) is used as the additional factor. Accordingly, the search result extraction means 230 measures the CTR with respect to a search listing inputted from the advertiser 130 for a predetermined advertisement period, determines an extraction ranking with respect to each search listing by using at least one of an advertisement period, CTR, and a bid participation cost, and extracts a search listing within a predetermined grade, based on the determined extraction ranking. Hereinafter, it will be described with reference to FIGS. through 7 to determine an extraction ranking of a search listing by the search result extraction means 230.

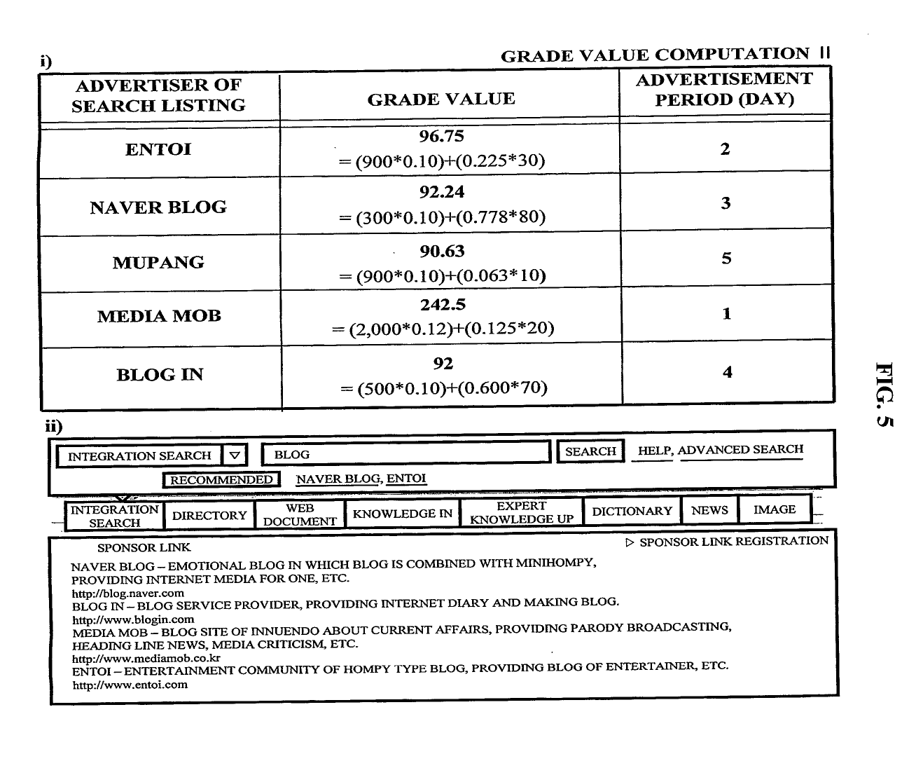

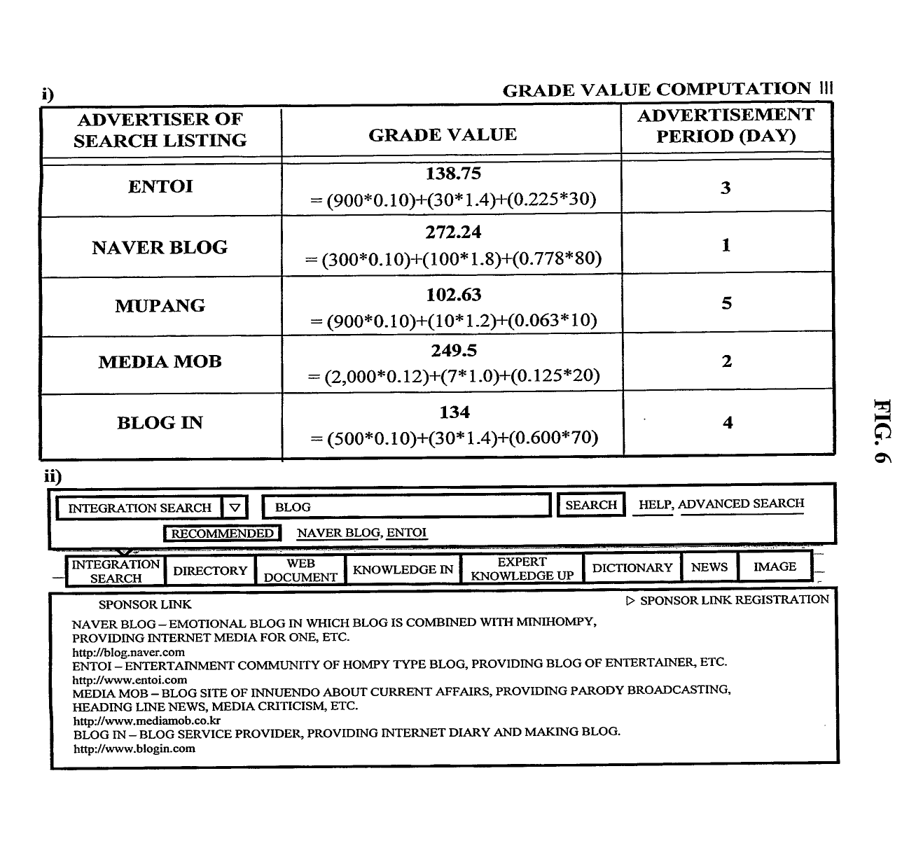

FIGS. 4 through 7 are diagrams illustrating determining an extraction ranking of a search listing of the present invention. FIG. 4 illustrates an advertisement period as an additional factor. FIG. 5 illustrates CTR as the additional factor. FIG. 6 illustrates a case of designating the advertisement period and CTR as the additional factor. FIG. 7 illustrates a weight applied to each of a bid participation cost and additional factors.

A case of designating an advertisement period as an additional factor is described with reference to FIG. 4. As described above, the advertisement period is information on a period that a search listing stored in the search information database 210 is maintained in a standby state. For example, the advertisement period may be inputted according to random determination of the advertiser 130 when a keyword advertisement is registered. In case that a keyword registered in an inputted period is inputted in the search engine 110 by the searcher 120 for a search request, a search listing corresponding to the keyword is extracted as a search result via a predetermined bidding process. In this case, relatively high grade value is computed on a search listing of an advertiser inputting a long advertisement period, which is due to determination that the search listing having a long advertisement period causes a relatively high advertisement effect. In i) of FIG. 4, it is illustrated that an extraction ranking is determined by using a bid participation cost and an advertisement period stored in a search information database 310 of FIG. 3.

For example, a predetermined grade value ‘210’(=300×0.10+100×1.8) computed by using weight information of FIG. 7 may be associated with a search listing of an advertiser ‘naver blog’, whose inputted advertisement period is longest as ‘100 days’. After, a grade value computed by the same method as described above is associated with each of search listings. The search result extraction means 230 compares each grade value with each other and adds a relatively preferential extraction ranking to a search listing associated with high grade value. According to comparing the size of the grade value, the extraction ranking of the advertiser ‘naver blog’ is second grade. In case that the keyword ‘blog’ is inputted by the searcher 120, it may be controlled that a search listing associated with the advertiser ‘naver blog’ is extracted next to a search listing of an advertiser ‘media mob’ whose extraction ranking is first grade. Also, in ii) of FIG. 4, search listings within a grade, for example, fourth grade, set-up based on the added extraction ranking are extracted, and the extracted search listings are arranged into a search result list by rolling. Namely, the search result extraction means 230 extracts a predetermined number of search listings corresponding to an inputted keyword based on the extraction ranking and controls to provide the search listings arranged in the search result list by rolling of the search result list generation means 240 described later as a search result to the searcher 120. In ii) of FIG. 4, it is illustrated that search listings associated with advertisers within fourth grade of the extraction ranking, such as ‘media mob’, ‘naver blog’, ‘entoi’, and ‘mupang’, are arranged in a search result list by rolling. On the other hand, a search listing of an advertiser ‘blog in’, whose extraction ranking is fifth grade other than set-up grade is excluded from the extracted search listings and is not extracted.

In addition, not shown in FIG. 3, the search information database 210 may further include information on a time point that an advertisement period ends. In case that the searcher 120 inputs a keyword after the time point that the advertisement period ends, adding an extraction ranking of a search listing is finished, thereby preventing the progress of extracting the search listing. In the present embodiment, though inputting an advertisement period by the advertiser 130 is illustrated, this is only an example of the present invention. A period that a search listing is maintained in the search information database and total accumulated period of previously inputted advertisement period may be designated as an advertisement period. The advertisement period may be flexibly set-up by the manager of the present system.

Next, a case of designating CTR as an additional factor is described with reference to FIG. 5. The CTR designates the percentage of the number of performing click selection by the searcher 120 over the number of providing an extracted search listing arranged in a search result list to the searcher 120. The CTR may be a standard data to estimate the popularity of the search listing. The described advertisement period inputted from the advertiser 130 may be preferable as a period to be measured, which participates in computing the CTR. In addition, a predetermined previous period set-up by the manager of the present system may be preferable. In the present embodiment, for convenience of description, the period to be measured of the CTR is limited to the advertisement period of the advertiser 130, which is currently progressed. Namely, in FIG. 5, the search result extraction means 230 determines an extraction ranking of a search listing by using CTR measured in an advertisement period inputted by the advertiser 130. This is for reflecting the current interest tendency of the searcher 120 on determining an extraction ranking of a search listing. A search listing causing high popularity must be preferentially extracted as a search result from advertised search listings to the searcher 120.

For example, in i) of FIG. 5, a search listing of the advertiser ‘naver blog’, whose CTR is highest as ‘0.778’ may obtain a predetermined grade value by using weight information of FIG. 7. The grade value ‘94.24’ is computed by an equation [symbol] 300×0.10+0.778×80 [symbol] . After, the grade value of each search listing is computed by the same method as described above. The search result extraction means 230 compares each grade value and adds a relatively preferential extraction ranking to a search listing whose grade value is high. According to comparing the grade value, the extraction ranking of the advertiser ‘naver blog’ is third grade. In case that a keyword ‘blog’ is inputted by the searcher 120, the search listing associated with the advertiser ‘naver blog’ is controlled to be extracted for the third time. Also, in ii) of FIG. 5, search listings within fourth grade set-up based on the added extraction ranking are extracted and arranged at random in a search result list by rolling. In ii) of FIG. 5, the search result extraction means 230 arranges at random the search listings associated with the advertisers such as ‘media mob’, ‘entoi’, ‘naver blog’, and ‘blog in’, which are in the fourth grade in the extraction ranking. On the other hand, the search listing of the advertiser ‘mupang’, which is extracted in FIG. 4, receives the extraction ranking of fifth grade according to changing the sort of the additional factor and is out of the set-up grade to be excluded from the search listing to be extracted. Namely, the extraction ranking added to each search listing may be differently changed according to changing the sort of the additional factor. Accordingly, the manager of the present system may easily analogize various methods of extracting search listings.

Also, it is explained in FIG. 6 a case in which the described advertisement period and the CTR are designated together as the additional factor. Namely, in the present embodiment, an extraction ranking is determined by simultaneously considering both items of the advertisement period and the CTR. A relatively high extraction ranking may be added to a search listing of the advertiser 130, whose both items are all superior. For example, as described in FIGS. 4 and 5, in case that the additional factor is separately defined as the advertisement period or the CTR, the search listing of the advertiser ‘naver blog’ whose grade value is computed as relatively low is computed as the highest grade value in i) of FIG. 6 in which the advertisement period and the CTR are all considered. It is shown that the advertiser ‘naver blog’ that can not receive a high extraction ranking due to relatively low bid participation cost may be computed as a high grade value in a state of considering the both of the advertisement period and the CTR. Accordingly, the keyword advertisement service system 200 changes an object of definition in many ways, as the additional factor, thereby optimizes a method of determining an extraction ranking to a system environment. Also, in ii) of FIG. 6, the extracted search listing is arranged at random in a search result list by rolling.

FIG. 7 illustrates an example of a weight set-up with respect to a bid participation cost and an additional factor. The weight applied to the bid participation cost and the additional factor may be flexibly set-up/changed by the manager of the present system, who considers the system environment. Accordingly, the manager of the present system may add diverse extraction rankings with respect to each sear listing according to changing the size of the weight set-up in FIG. 7. Via this, effects are obtained, in which distinguished keyword advertisement service may be managed and a new keyword advertisement market may be created being out of a uniform keyword advertisement method (for example, a method based on the size of bidding cost).

The search result list generation means 240 is a unit that arranges extracted search listings into a predetermined search result list by rolling and provides the search result list as a search result. Namely, the search result list generation means 240 arranges extracted search listings into a search result list in random order but determines the exposure position of the search listing displayed to the searcher 120. In this case, the search result list may be a search result provided to the searcher 120 generating a search request. Each of the extracted search listings occupies a different exposure position and is displayed in the search result list. Generally, an exposure position on a search result list may cause a difference in the degree of recognition of the searcher 120, with respect to the displayed search listing, and may cause a difference in a frequency of connecting the searcher 120 with the advertiser 130 by click selected by the searcher 120. Accordingly, the rolling of the present embodiment to determine an exposure position of a search listing controls that a certain search listing is not continuously located in an exposure position in which the search listing is previously located, thereby generating proper and balanced advertisement effects in all search listings. A search result list in which search listings are arranged by the rolling is displayed in the terminal means 125 of the searcher 120 as a search result corresponding to a search request of the searcher 120 (refer to FIGS. 4, 5, and 6).

Accordingly, in the present invention, a predetermined number of search listings are extracted based on a bid participation cost and additional factors which are additional information data in response to a search request but the extracted search listings are arranged at random by rolling, thereby providing effects of preventing excessive competition for obtaining an exposure position of a search listing and keeping wholesome market order of a keyword advertisement market.

Hereinafter, as another embodiment of the present invention, a configuration in which a predetermined advertisement cost is generated according to one click of the searcher 120, with respect to a certain search listing arranged in a search result list, and the generated advertisement cost is charged on the advertiser 130 will be described.

For this, the keyword advertisement service system 200 of the present invention further may include the advertisement cost determination means 250.

Namely, the advertisement cost determination means 250 is a unit generating information on advertisement cost according to generating one click with respect to a predetermined search listing arranged in a search result list. Namely, the advertisement cost determination means 250 is a kind of a payment control means, which determines an advertisement cost charged according to a click selection of the searcher 120, with respect to a search listing arranged in a search result list. In the present embodiment, an the advertisement cost with respect to the search listing arranged in the search result is determined to be identical according to the click selection, according to the goal of the present invention, in which extracted search listings are provided to the searcher 120 in a state of being arranged at random by rolling. The is due to the rolling of the present invention, in which an exposure position on a search result list in which search listings are arranged is not to be specified. The advertisement cost with respect to all search listings arranged in the search result list are kept to be the same, thereby preventing an unfair factor to a certain search listing in determining the advertisement cost. In the present embodiment, there is no particular limitation on determining the advertisement cost, but it is preferable that a bid participation cost inputted as a minimum from bid participation costs associated with search listings arranged in the search result list is determined to be an advertisement cost with respect to all search listings. In addition, there are various advertisement cost determination methods such as a bid participation cost associated with the highest search listing (the search listing of the advertiser ‘blog in’ of FIG. 4) from search listings not extracted by the search result extraction means 230 is determined to be an advertisement cost. This may be flexibly determined by the manager of the present system, who considers the system environment. For example, the determined advertisement cost is subtracted from an advertisement deposit of an account associated with an advertiser, coupled with one click of the searcher 120, thereby performing payment of the advertisement cost.

Accordingly, in the present invention, the advertisement cost is charged according to click selection of the searcher 120, with respect to a search listing arranged in a search result list, thereby performing reasonable payment and allowing the advertiser 130 to obtain more efficiently advertisement effect.

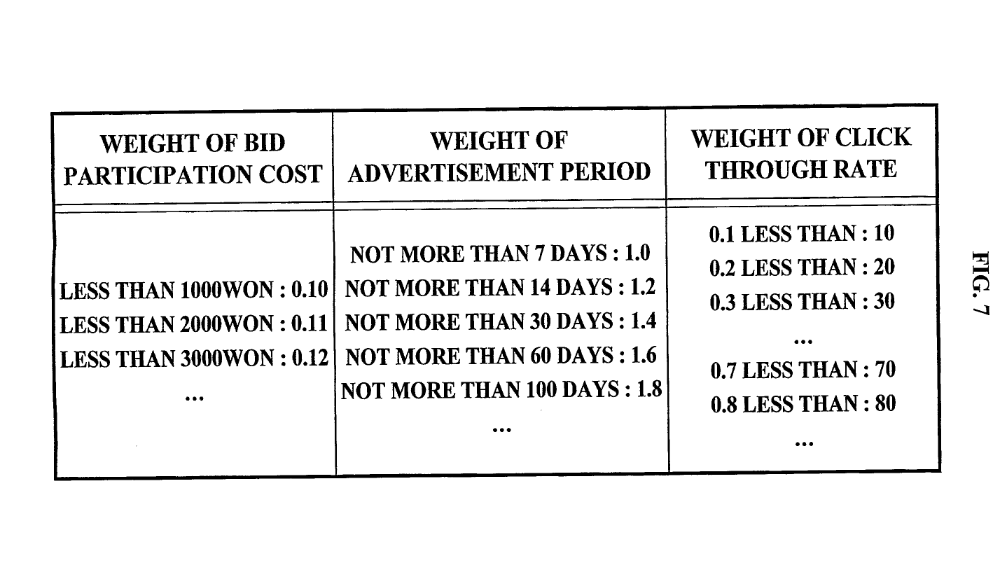

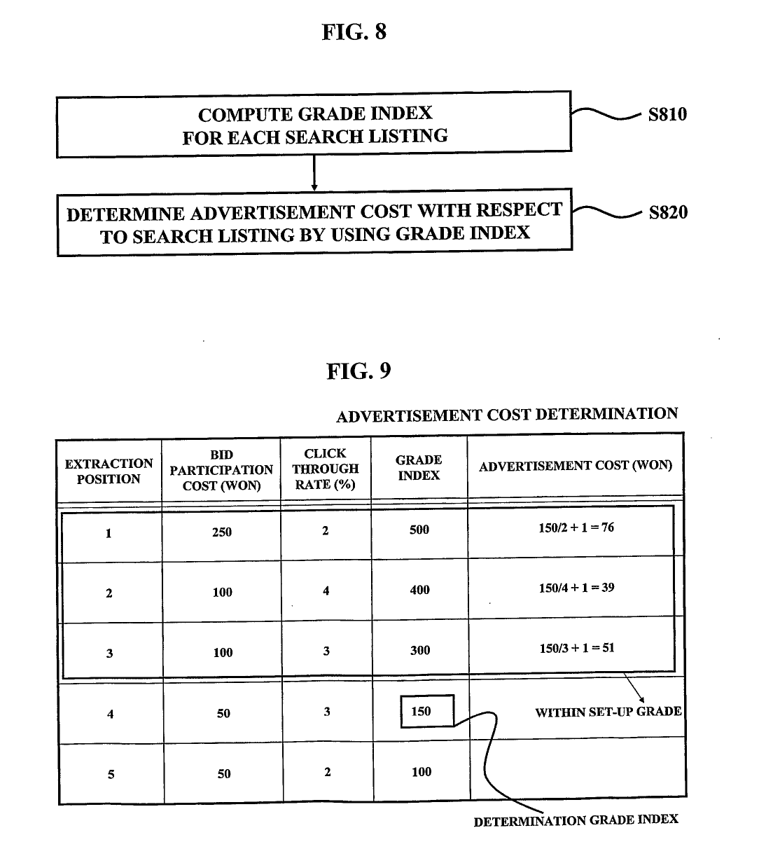

Hereinafter, referring to FIGS. 8 and 9, it is described that the advertisement cost with respect to the search listing arranged in the search result list is determined by using a predetermined grade index.

FIGS. 8 and 9 are diagrams illustrating an example of determining an advertisement cost different for each search listing by using a grade index according to the present invention.

In the present embodiment, a search listing is extracted as a search result of a search request, based on a grade index computed by multiplying a bid participation cost by CTR. Via this, in the present invention, the advertiser 130 of the search listing is induced to present a high bid participation cost for extracting the search listing and provide contents of high quality and high popularity, and the advertisement cost may be determined to be different for each search listing by using the differently presented bid participation cost and CTR for a predetermined period.

Namely, as FIG. 8, the advertisement cost determination means 250 computes a predetermined grade index for each search listing maintained in the search information database 210 by multiplying a bid participation cost by a predetermined CTR (S810). Step 810 is a process of computing the grade index that becomes an extraction standard of a search listing, in which a grade index is computed by multiplying the bid participation cost presented by the advertiser 130 of a search listing by the CTR from previous time point to a predetermined time point. As described above, the grade index becomes a standard for selecting a search listing extracted as a search result in response to a search request, for example, the search result extraction means 230 determines an extraction ranking of the search listing according to the size of the grade index.

The advertisement cost determination means 250 generates information on advertisement cost according to generating one click with respect to the search listing arranged in the search result list by using the computed grade index (S820). Step 820 is a process of computing a cost per click (CPC) index that is the advertisement cost with respect to the extracted search listing, in which the advertisement cost with respect to the search listing extracted as a search result is determined based on a predetermined equation. In this case, the advertisement cost is determined while satisfying an equation ‘(determination grade index/CTR)+a predetermined value’, and the determination grade index may be defined as a grade index associated with a search listing of the highest grade from search listings excepting set-up grades.

For example, as FIG. 9, the grade index of each search listing is computed by multiplying the bid participation cost by the CTR, and the extraction ranking of each search listing is determined according to the size of the computed grade index. If a set-up grade is ‘third grade’ in the present embodiment, the search result extraction means 230 extracts a search listing whose extraction ranking is from first to third. On the other hand, the advertisement cost determination means 250 determines a grade index ‘150’ associated with a search listing whose extraction ranking is fourth grade that is the highest extraction ranking except the search listings whose extraction ranking is from first grade to third grade. In addition, the advertisement cost determination means 250 determines the advertisement cost of each search listing based on the described equation ‘(determination grade index/CTR)+a predetermined value. In this case, the predetermined value may be flexibly determined by the manager of the present system, and illustrated as ‘1’ in FIG. 9. For example, the advertisement cost determination means 250 determines an advertisement cost of an extraction ranking first grade is determined to be ‘76’ by the equation ‘150/2+1’ and charges the determined advertisement cost ‘76’ as the search listing is selected by a click of the searcher 120. Also, the advertisement cost determination means 250 determines each of the advertisement cost with respect to other search listings arranged in the search result list by rolling according to the equation, as shown in FIG. 9.

Accordingly, according to the present embodiment, a search listing is extracted and rolled as a search result according to the bid participation cost that is a cost capable of being paid by the advertiser 130 and CTR in which the popularity of the search listing is reflected, and an advertisement cost charged on each of the extracted search listing is different from each other, thereby obtaining an effect of enabling CPC subtraction in which it is subtracted for each search listing.

In the present embodiment, an advertisement cost is generated at a time point of generating one click by the searcher 120, with respect to a search listing. This is only an example of the present invention. For example, there is an advertisement cost generated at various time points, such as an advertisement cost is generated at a time point of exposing a search listing or clicking a predetermined purchase button by a command input device of the searcher 120 in case that the kind of a bid participation cost is the described unit exposure cost or unit purchase cost.

A flow of the operations of the keyword advertisement service system 200 according to the present invention is described in detail.

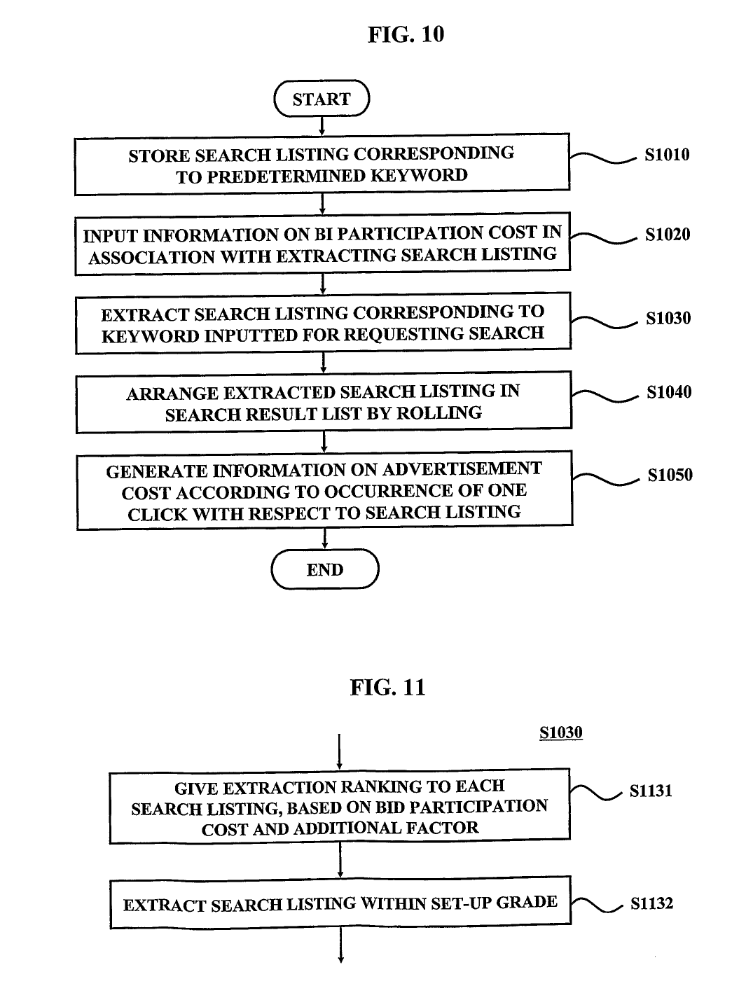

FIG. 10 is a flow chart concretely illustrating a keyword advertisement service method according to a preferable embodiment of the present invention.

The keyword advertisement service method according to the present embodiment is performed by the described keyword advertisement service system 200.

The keyword advertisement service system 200 maintains the search information database 210 for storing at least one search listing corresponding to a predetermined keyword (S1010). Step 1010 is a process of storing a search listing of the searcher 130 by grouping based on a keyword registered for a keyword advertisement, in which a search listing of the advertiser 130 inputting a common keyword that is a cause for extracting the search listing is maintained while classified into a certain storage area, thereby easily and rapidly identifying the search listing corresponding to the keyword inputted for a search request.

Also, the keyword advertisement service system 200 receives information on a predetermined bid participation cost in association with extracting the search listing from the advertiser 130 (S1020). Step 1020 is a process of receiving a bid participation cost participating in extracting the search listing and computing an advertisement cost from each advertiser 130, in which the inputted bid participation cost is stored and maintained in the search information database 210 by establishing the relationship with the search listing (refer to FIG. 3). In the present embodiment, there is no particular limitation on a time point of inputting the bid participation cost, and it is preferable to allow the advertiser 130 to input the bid participation cost at any time, who considers a preferable advertisement period. The search listing associated with the bid participation cost is on standby to be extracted for a predetermined advertisement period and may be extracted as a search result in case that the registered keyword is inputted as a search request.

Next, the keyword advertisement service system 200 extracts at least some of search listings corresponding to the keyword inputted for search request (S1030). Step 1030 is a process of selecting at least one search listing stored in the search information database 210 caused by the keyword inputted when the searcher 120 requests a search. Particularly, in Step 1030, the keyword advertisement service system 200 gives an extraction ranking to each of search listings based on not only the size of the bid participation cost but also a predetermined additional factor and controls to extract a search listing within a set-up grade. Hereinafter, extracting the search listing is explained with reference to FIG. 11.

FIG. 11 is a flow chart illustrating an example of a method of determining the extraction ranking with respect to the search listing, according to the present invention.

As illustrated in FIG. 11, the keyword advertisement service system 200 gives the extraction ranking to each of the search listings corresponding to the keyword, based on the bid participation cost and the predetermined additional factor (S1131). Step 1131 is a process of identifying the keyword inputted for the search request and computing a predetermined grade value. The grade value may be computed by applying a designated weight to the bid participation cost and the additional factor. The keyword advertisement service system 200 gives the extraction ranking to each of the search listings in order to determine a search listing preferentially extracted as the search result corresponding to the keyword via comparing the computed grade values.

Also, the keyword advertisement service system 200 extracts the search listings within the set-up grade (S1132). Step 1132 is a process of selecting the search listings within set-up N grade from at least one search listing corresponding to the inputted keyword, in which N is a natural number more than 0. Namely, in Step 1132, the keyword advertisement service system 200 extracts the search listings within the N grade by considering the number of the search listings provided to the searcher 120 and the number of the search listings arranged in the search result list. Also, the set-up grade N may be flexibly determined by the manager of the present system, who considers an occupied area in which the search result list is displayed on a search screen.

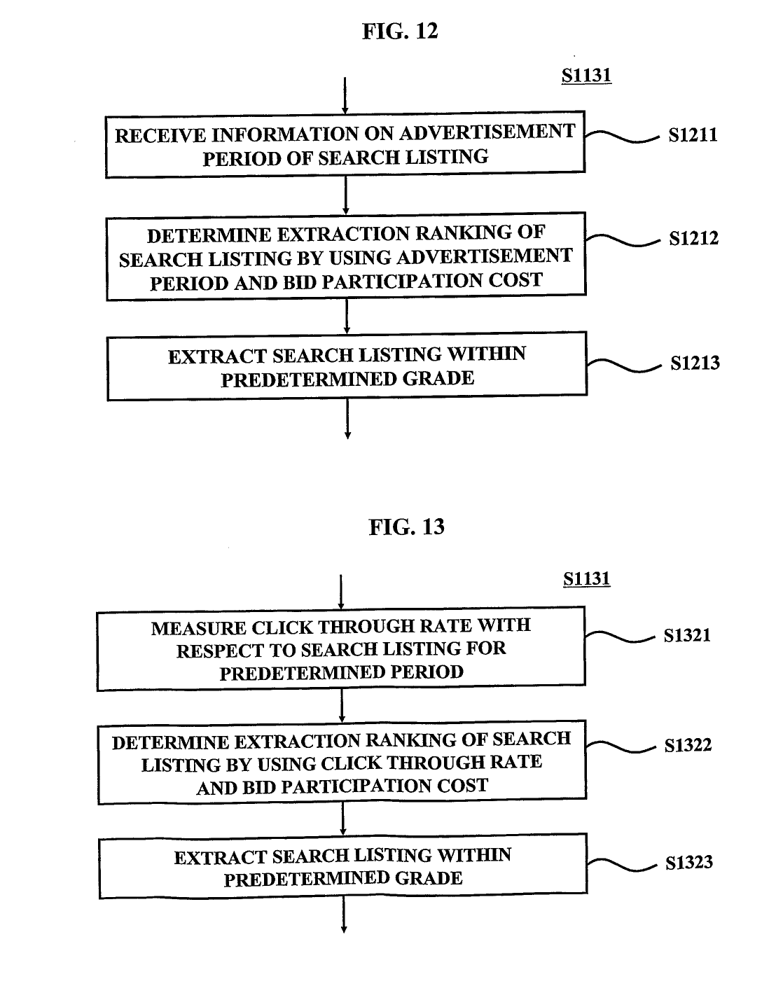

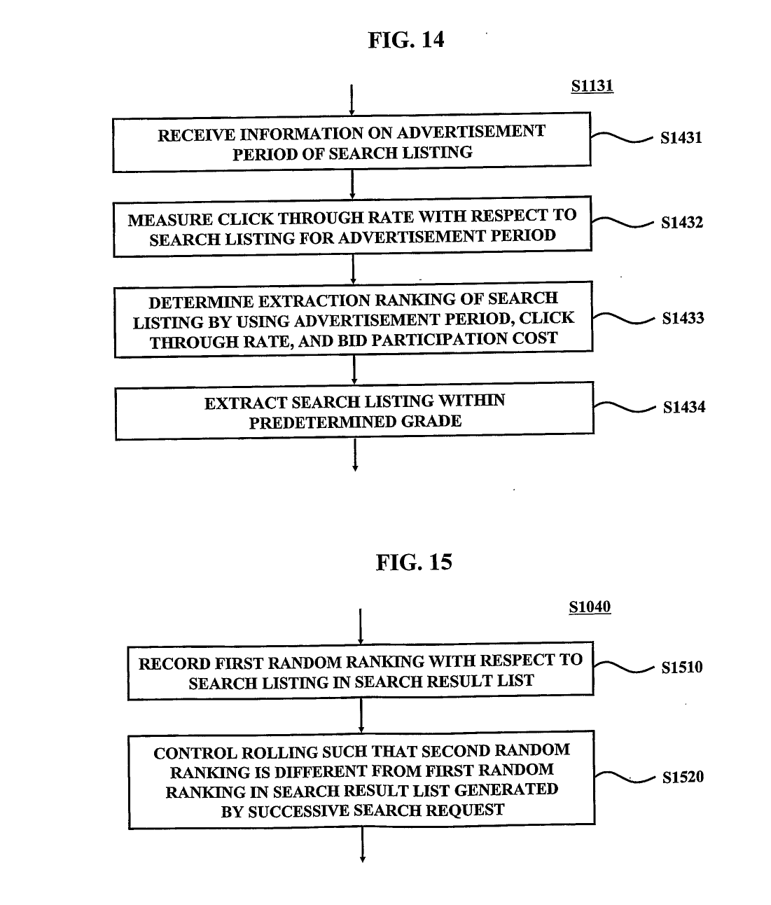

An advertisement period or CTR may be used as the additional factor. Hereinafter, a method of determining an extraction ranking added to a search listing with reference to FIGS. 12 and 14.

FIG. 12 is a flow chart illustrating an example of a method of giving an extraction ranking of a search listing by using an advertisement period as the additional factor according to the present invention.

The keyword advertisement service system 200 receives information on an advertisement period of a search listing from the advertiser 130 (S1211). Step 1211 is a process of receiving information on the advertisement period defined as the additional factor, in which information on a certain period in which the search listing stored in the search information database 210 is activated in a state of being on standby to be extracted is received from the advertiser 130. The state of being on standby to be extracted may designate the condition of a state in which the search listing corresponding to the keyword inputted for a search request by the searcher 120 is extracted as a search result.

Also, the keyword advertisement service system 200 determines an extraction ranking for each search listing by using the received advertisement period and bid participation cost (S1212). Step 1212 is a process of computing a grade value by applying a designated weight to the advertisement period and bid participation cost inputted from the advertiser 130, in which the extraction ranking of the search listing is determined via comparing the size of the computed grade value (refer to FIGS. 4 and 7). In the present embodiment, since the advertisement period is defined as the additional factor, the weight is applied by time lag unit (refer to FIG. 7). In addition, in case that the additional factor is changed or compound data is included, an optimized weight may be applied for each predetermined unit according to the kind of the data.

Next, the keyword advertisement service system 200 extracts search listings within a predetermined grade based on the determined extraction ranking (S1213). Step 1213 is a process of selecting the search listings within the N grade set up by the manager of the present system as a search result corresponding to the search request. For example, in case that N is 4, it is controlled that the search listings within the 4 grade of extraction ranking are extracted.

Accordingly, according to the present invention, information on the advertisement period in which an advertisement effect is substantially exhibited is reflected in extracting the search listing, thereby preferentially extracting a search listing capable of causing the generation of the advertisement cost in a long time.

FIG. 13 is a flow chart illustrating an example of a method of giving an extraction ranking of a search listing by using CTR as the additional factor according to the present invention.

The keyword advertisement service system 200 measures CTR with respect to a search listing for a predetermined period (S1321). Step 1321 is a process of generating information on CTR defined as the additional factor, in which CTR with respect to a certain search listing for a period set up by the manager of the present system is computed. As described above, CTR may be used as data estimating the popularity of the search listing, and a period in which CTR is measured may be an advertisement period inputted by the advertiser 130. Accordingly, the current tendency of the popularity of the search listing can be reflected in extracting a search listing.

Also, the keyword advertisement service system 200 determines an extraction ranking with respect to each search listing by using the measured CTR and bid participation cost (S1312). Step 1312 is a process of computing a grade value by applying a designated weight to CTR for the selected period and bid participation cost, in which the extraction ranking of the search listing is determined via comparing the size of the computed grade value (refer to FIGS. 5 and 7).

Next, the keyword advertisement service system 200 extracts the search listings within a predetermined grade based on the determined extraction ranking (S1323). Step 1323 is similar to Step 1213 that is the process of selecting the search listing, in which N search listings (within N grade) are selected as a search result and extracted.

Accordingly, according to the present invention, the current popularity of the searcher 120 with respect to the search listing is reflected in extracting the search listing, thereby preferentially extracting a search listing inducing much interest of the searcher 120 and maintaining high access rate of the searcher 120.

FIG. 14 is a flow chart illustrating an example of a method of giving the extraction ranking of the search listing by using the advertisement period and CTR as the additional factors.

The keyword advertisement service system 200 receives information on the advertisement period of the search listing from the advertiser 130 (S1431). Step 1431 is process of receiving information on an advertisement period as an additional factor, in which information on a period in which the search listing is activated in a state of being on standby to be extracted (for example, start time point and finish time point of the advertisement period) is received.

Also, the keyword advertisement service system 200 measures CTR with respect to the search listing for the received advertisement period (S1432). Step 1432 is a process of defining the period for measuring CTR as the advertisement period inputted by the advertiser 130 and computing the percentage of click selection number with respect to the number of exposing a certain search listing in the advertisement period. The measured CTR is generated each time the search listing is exposed/clicked for the advertisement period and recorded in the search information database while updated.

Next, the keyword advertisement service system 200 determines an extraction ranking for each search listing by using the advertisement period, CTR, and the bid participation cost (S1433). Step 1433 is a process of computing a grade value by applying a designated weight to each of the advertisement period inputted by the advertiser 130, CTR measured for the inputted advertisement period, and the bid participation cost, in which the extraction ranking of the search listing is determined via comparing the size of the computed grade value (refer to FIGS. 6 and 7). Namely, In Step 1433, the keyword advertisement service system 200 considers a plurality of additional factors to reflect an advertisement effect with respect to the search listing or the popularity of the searcher 120, thereby providing a condition to develop various methods of extracting a search listing.

Also, the keyword advertisement service system 200 extracts the search listing within a predetermined grade, based on the determined extraction ranking (S1434). Step 1434 is similar to Step 1213 or Step 1323, which is a process of selecting the search listing, in which the N search listings (within an N grade) are selected and extracted as a search result.

Accordingly, according to the present invention, it is prevented that the extraction ranking of the search listing is bigotedly performed by using one data in case that one additional factor is considered and a plurality of additional factors are flexibly applied, thereby using more various methods of extracting a search listing.

Referring to FIG. 10, the keyword advertisement service system 200 arranges the extracted search listing in a predetermined search result list by rolling and provides the search result list as a search result of the search request (S1040). Step 1040 is a process of determining the exposure position of the extracted search listing at random in the search result list, in which the search result list generated as the search result corresponding to the search request is displayed in the terminal means 125 (refer to ii) of FIG. 4, ii) of FIG. 5, and ii) of FIG. 6)

Accordingly, in the present invention, a predetermined number of search listings are extracted according to the bid participation cost and various additional factors in response to the search request and the extracted search listing is arranged at random by rolling to be provided to the searcher 120, thereby displaying an optimized search listing that the searcher 120 wants to find in the exposure position that continuously changed.

Also, according to another embodiment of the present invention, information on the advertisement cost is generated according as the searcher 120 performs click selection with respect to the provided search listing.

For this, the keyword advertisement service system 200 generates information on the advertisement cost according to the occurrence of one click with respect to the search listing arranged in the search result list (S1050). Step 1050 is a process of charging a predetermined advertisement cost on the advertiser 130 according to the click selection of the searcher 120 with respect to the search listing. Particularly, in the present embodiment, the advertisement costs charged for at least one search listing arranged in the same search result list can be generated to be identical for all search listings as a certain bid participation cost. This is due to the rolling of the present invention to change the exposure position in which the extracted search listing is displayed at each time a search request is generated. For example, a minimum bid participation cost from the bid participation cost of the search listing arranged in the search result list may be determined to be the advertisement cost. The same advertisement cost is charged with respect to the search listing whose advertiser 130 is different, in which the feature of the present invention, in which the exposure position of the search listing is not specified by rolling, is considered. At least an advertisement cost not more than the bid participation cost that the advertiser inputs is charged on the advertiser, thereby providing economical keyword advertisement service.

Hereinafter, according to another embodiment of the present invention, the extraction ranking previously given to a certain search listing is not continuously or repeatedly given.

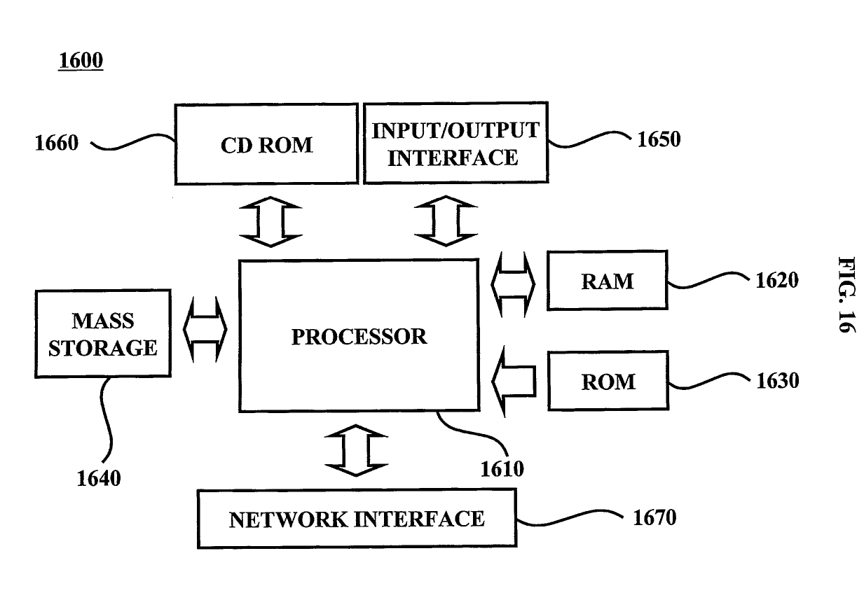

FIG. 15 is a flow chart illustrating an example of a method of excluding an operation of sequentially giving the same extraction ranking to a certain search listing by recording random rankings, which is according to the present invention.

The keyword advertisement service system 200 records a first random ranking with respect to a search listing in a search result corresponding to a search query including a keyword (S1510). Step 1510 is a process of storing the exposure position of the search listing extracted in response to a previously generated search request as history information, in which a random ranking given to each search listing by rolling is recorded.

For example, the search listing of the advertiser ‘media mob’ is located at the highest exposure position in the search result list, and the keyword advertisement service system 200 records that the search listing of the advertiser ‘media mob’ occupies ‘a first grade’ exposure position as the history information.

Also, the keyword advertisement service system 200 controls the rolling such that a second random ranking with respect to a certain search listing in the search result list generated by a successive search request including the same keyword is different from the first random ranking (S1520). In case that search requests are generated by the same keyword and the search listings extracted in Step 1510 are extracted again, a restriction, by which the search listings are controlled not to be located at the exposure position where the search listings were previously located, will be applied in Step 1520. This is for preventing a certain search listing from being continuously located at one exposure position by rolling (accidentally), thereby locating the search listing at various exposure position by turns. Therefore, it may be possible to seriously arrange the search listing at random by rolling. In the present embodiment, there is a restriction on that the exposure position of the search listing is continuously determined at the same point. In addition, there may be various arrangement methods using rolling, such as it is completely restricted to determine to the exposure position recorded as the search listing is previously located under a set-up condition.

Also, the embodiments of the present invention include a computer readable medium including a program instruction for executing various operations realized by a computer. The computer readable medium may include a program instruction, a data file, and a data structure, separately or cooperatively. The program instructions and the media may be those specially designed and constructed for the purposes of the present invention, or they may be of the kind well known and available to those skilled in the art of computer software arts. Examples of the computer readable media include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level languages codes that may be executed by the computer using an interpreter.

FIG. 16 is a block diagram of the inside of a general use computer apparatus that may be employed in performing the keyword advertisement service method according to the present invention.

A computer apparatus 1600 includes at least one processor 1610 connected to a main memory device including a RAM (Random Access Memory) 1620 and a ROM (Read Only Memory) 1630. The processor 1610 is also called as a central processing unit CPU. As well-known to the field of the art, the ROM 1630 unidirectionally transmits data and instructions to the CPU, and the RAM 1620 is generally used for bidirectionally transmitting data and instructions. The RAM 1620 and the ROM 1630 may include a certain proper form of a computer readable recording medium. A mass storage device 1640 is bidirectionally connected to the processor 1610 to provide additional data storage capacity and may be one of the computer readable recording medium. The mass storage device 1640 is used for storing programs and data and is an auxiliary memory. A particular mass storage device such as a CD ROM 1660 may be used. The processor 1610 is connected to at least one input/output interface 1650 such as a video monitor, a track ball, a mouse, a keyboard, a microphone, a touch-screen type display, a card reader, a magnetic or paper tape reader, a voice or hand-writing recognizer, a joy stick, and other known computer input/output unit. The processor 1610 may be connected to a wired or wireless communication network via a network interface 1670. The procedure of the described method can be performed via the network connection. The described devices and tools are well-known to those skilled in the art of computer hardware and software.

The hardware elements above may be configured to act as one or more software modules for implementing the operations of this invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

Therefore, it is intended that the scope of the invention be defined by the claims appended thereto and their equivalents.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

### INDUSTRIAL APPLICABILITY

As known from the described above, according to the present invention, there are provided a keyword advertisement service method and a keyword advertisement service system extracting a search listing in response to a search request, which determine an extraction ranking by reflecting an advertisement effect according to an advertisement period of a search listing and the popularity among searchers in addition to a bid participation cost, thereby giving an impartial advertisement opportunity with respect to the search listing and extracting a search listing optimized to the searcher.

Also, according to the present invention, there are provided a keyword advertisement service method and a keyword advertisement service system extracting a search listing in response to a search request, which arrange the extracted search listing at random by rolling, thereby excluding excessive competition for occupying an exposure position, and charging an identical advertisement cost on the search listing regardless of the exposure position, thereby computing a reasonable advertisement cost.

Also, according to the present invention, there are provided a keyword advertisement service method and a keyword advertisement service system extracting a search listing in response to a search request, in which it is restricted that an extraction ranking to the same exposure position is continuously determined such that the exposure position where the extracted search listing is displayed is not monopolized by a certain search listing, thereby flexibly controlling the determination on the extraction ranking of the search listing.

1. A keyword advertisement service method for extracting a search listing of an advertiser in response to a search request, comprising the steps of:
receiving at least one bid in association with a keyword from advertisers, the bid indicating, at least in part, a bid participation cost, the keyword and a search listing;
maintaining a search information database, the search information database storing the search listing associated with the keyword and the bid participation cost;
receiving a search request from a searcher;
identifying the one or more stored search listings in response to the search request;
determining extraction rank for the one or more identified search listings in accordance to the bid participation cost and at least one of a predetermined click through rate (CTR) for exposure and an advertising period as an additional factor;
extracting at least one of the identified search listings based, at least in part, upon the extraction rank; and
arranging the extracted search listings into a search result list in response to the search request.

2. The method of claim 1, further comprising a step of generating information on an advertisement cost according to generating a single click with respect to the search listing arranged in the search result list, in which the advertisement cost is determined to be identical with the search listing arranged in the search result list.

3. The method of claim 2, wherein the minimum bid participation cost from the bid participation cost of the search listing arranged in the search result list is determined as the advertisement cost.

4. The method of claim 2, wherein the bid participation cost is one of cost per click, cost per impression, and cost per purchase.

5. The method of claim 1, further comprising the steps of:
calculating a predetermined order index for each the search listing maintained in the search information database by multiplying the bid participation cost by the predetermined click through rate (CTR) for exposure; and
generating information on an advertisement cost according to occurrence of the single click with respect to the search listing arranged in the search result list by using the calculated order index,
wherein the advertisement cost is obtained by an equation ‘(determination order index/click through rate (CTR) for exposure)+a predetermined value’ and determined to be different from the search listing, in which the determination order index is defined as an order index associated with the search listing of a top priority from the rest search listing except the set order.

6. The method of claim 1, wherein a predetermined number of the identified search listings are extracted based at least in part, upon the extraction rank.

7. The method of claim 1, wherein the additional factor is information on click through rate (CTR) for exposure, and further comprising a step of measuring the click through rate (CTR) for exposure with respect to the search listing for a predetermined period.

8. The method of claim 1, wherein the additional factor is information on an advertising period and click through rate (CTR) for exposure of a certain search listing and the step of determining extraction rank for the one or more identified search listings comprises the steps of:
receiving information on the advertising period of the search listing from the advertiser;
measuring the click through rate (CTR) for exposure with respect to the search listing for the received advertising period;
determining an extraction rank for each the search listing by using the advertising period, the click through rate (CTR) for exposure, and the bid participation cost; and
extracting a search listing not more than a predetermined order based on the determined extraction rank.

9. The method of claim 1, wherein the extraction rank is determined based on comparing grade value calculated by applying a selected weight to each of the advertising period, the click through rate (CTR) for exposure, and the bid participation cost.

10. The method of claim 1, wherein the extracted search listings are arranged into the search result list by rolling the extracted search listings, and the step of arranging the extracted search listings by rolling the same comprises the steps of:
recording a first random order with respect to the search listing in the search result list in response to the search request associated with the keyword; and
a controlling the order of the search listings such that a second random order for the search listing in the search result list in response to a subsequent search request associated with the same keyword is different from the recorded first random order.

11. A computer readable storage medium encoded with a program for executing the method recited in claim 1.

12. A keyword advertisement service system for extracting a search listing of an advertiser in response to a search request, comprising:
a search information database, the search information database storing at least one search listing, the search listing being associated with a predetermined keyword;
an interface module, the interface module receiving a bid in association with a keyword from an advertiser, the bid indicating at least in part, a bid participation cost, the keyword and a search listing
a search result extraction module, the search result extraction module determining extraction rank for the one or more search listings in accordance to the bid participation cost and at least one of a predetermined click through rate (CTR) for exposure and an advertising period as an additional factor, the search result extraction module extracting at least one of the search listings based, at least in part, upon the extraction rank; and
a search result list generation module, the search result list generation module arranging the extracted search listing into a search result list in response to the search request.

13. The system of claim 12, further comprising an advertisement cost determination module, the advertisement cost determination module generating information on an advertisement cost according to the occurrence of a single click with respect to the search listing arranged in the search result list,
wherein the advertisement cost determination module determines the advertisement cost with respect to the search listing to be identical, in which the advertisement cost is determined as a minimum bid participation cost from the bid participation cost of the search listing arranged in the search result list.

14. The system of claim 12, wherein a predetermined number of the identified search listings are extracted based, at least in part, upon the extraction rank.
